(19) United States
(12) Patent Application Publication
(10) Pub. No.: US 2022/0400391 A1
(43) Pub. Date: Dec. 15, 2022

(54) ADJUSTING FEEDBACK TIMELINES FOR SPECTRUM SHARING DEPLOYMENTS

(71) Applicant: QUALCOMM Incorporated, San Diego, CA (US)

(72) Inventors: Jae Ho RYU, San Diego, CA (US); Hari SANKAR, San Diego, CA (US); Alexei Yurievitch GOROKHOV, San Diego, CA (US); Hobin KIM, San Diego, CA (US); Jae Won YOO, San Diego, CA (US); Faris RASSAM, El Cajon, CA (US)

(21) Appl. No.: 17/304,089

(22) Filed: Jun. 14, 2021

(51) Int. Cl. H04W 24/02; H04W 16/14; H04L 1/18; H04L 5/00; H04W 72/04

(52) U.S. Cl. CPC H04W 24/02; H04W 16/14; H04L 1/1819; H04L 1/1896; H04L 5/0051; H04W 72/042; H04W 72/0446

(57) ABSTRACT

Various aspects of the present disclosure generally relate to wireless communication. In some aspects, a mobile station may receive, from a base station, an indication of a relaxed physical downlink shared channel (PDSCH) hybrid automatic repeat request acknowledgement (HARQ-ACK) feedback timeline associated with a dynamic spectrum sharing (DSS) deployment in which a first radio access technology (RAT) and a second RAT share a same frequency band. The mobile station may receive, from the base station, a PDSCH associated with the first RAT. The mobile station may transmit, to the base station, PDSCH HARQ-ACK feedback for the PDSCH associated with the first RAT based at least in part on the relaxed PDSCH HARQ-ACK feedback timeline associated with the DSS deployment. Numerous other aspects are described.

### FIELD OF THE DISCLOSURE

Aspects of the present disclosure generally relate to wireless communication and to techniques and apparatuses for adjusting feedback timelines for spectrum sharing deployments.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, an apparatus for wireless communication at a UE includes a memory and one or more processors, coupled to the memory, configured to: receive, from a base station, an indication of a relaxed physical downlink shared channel (PDSCH) hybrid automatic repeat request acknowledgement (HARQ-ACK) feedback timeline associated with a dynamic spectrum sharing (DSS) deployment in which a first radio access technology (RAT) and a second RAT share a same frequency band; receive, from the base station, a PDSCH associated with the first RAT; and transmit, to the base station, PDSCH HARQ-ACK feedback for the PDSCH associated with the first RAT based at least in part on the relaxed PDSCH HARQ-ACK feedback timeline associated with the DSS deployment.

In some aspects, an apparatus for wireless communication at a base station includes a memory and one or more processors, coupled to the memory, configured to: transmit, to a UE, an indication of a relaxed PDSCH HARQ-ACK feedback timeline associated with a DSS deployment in which a first RAT and a second RAT share a same frequency band; transmit, to the UE, a PDSCH associated with the first RAT; and receive, from the UE, PDSCH HARQ-ACK feedback for the PDSCH associated with the first RAT based at least in part on the relaxed PDSCH HARQ-ACK feedback timeline associated with the DSS deployment.

In some aspects, a method of wireless communication performed by a UE includes receiving, from a base station, an indication of a relaxed PDSCH HARQ-ACK feedback timeline associated with a DSS deployment in which a first RAT and a second RAT share a same frequency band; receiving, from the base station, a PDSCH associated with the first RAT; and transmitting, to the base station, PDSCH HARQ-ACK feedback for the PDSCH associated with the first RAT based at least in part on the relaxed PDSCH HARQ-ACK feedback timeline associated with the DSS deployment.

In some aspects, a method of wireless communication performed by a base station includes transmitting, to a UE, an indication of a relaxed PDSCH HARQ-ACK feedback timeline associated with a DSS deployment in which a first RAT and a second RAT share a same frequency band; transmitting, to the UE, a PDSCH associated with the first RAT; and receiving, from the UE, PDSCH HARQ-ACK feedback for the PDSCH associated with the first RAT based at least in part on the relaxed PDSCH HARQ-ACK feedback timeline associated with the DSS deployment.

In some aspects, a non-transitory computer-readable medium storing a set of instructions for wireless communication includes one or more instructions that, when executed by one or more processors of a UE, cause the UE to: receive, from a base station, an indication of a relaxed PDSCH HARQ-ACK feedback timeline associated with a DSS deployment in which a first RAT and a second RAT share a same frequency band; receive, from the base station, a PDSCH associated with the first RAT; and transmit, to the base station, PDSCH HARQ-ACK feedback for the PDSCH associated with the first RAT based at least in part on the relaxed PDSCH HARQ-ACK feedback timeline associated with the DSS deployment.

In some aspects, a non-transitory computer-readable medium storing a set of instructions for wireless communication includes one or more instructions that, when executed by one or more processors of a base station, cause the base station to: transmit, to a UE, an indication of a relaxed PDSCH HARQ-ACK feedback timeline associated with a DSS deployment in which a first RAT and a second RAT share a same frequency band; transmit, to the UE, a PDSCH associated with the first RAT; and receive, from the UE, PDSCH HARQ-ACK feedback for the PDSCH associated with the first RAT based at least in part on the relaxed PDSCH HARQ-ACK feedback timeline associated with the DSS deployment.

In some aspects, an apparatus for wireless communication includes means for receiving, from a base station, an indication of a relaxed PDSCH HARQ-ACK feedback timeline associated with a DSS deployment in which a first RAT and a second RAT share a same frequency band; means for receiving, from the base station, a PDSCH associated with the first RAT; and means for transmitting, to the base station, PDSCH HARQ-ACK feedback for the PDSCH associated with the first RAT based at least in part on the relaxed PDSCH HARQ-ACK feedback timeline associated with the DSS deployment.

In some aspects, an apparatus for wireless communication includes means for transmitting, to a UE, an indication of a relaxed PDSCH HARQ-ACK feedback timeline associated with a DSS deployment in which a first RAT and a second RAT share a same frequency band; means for transmitting, to the UE, a PDSCH associated with the first RAT; and means for receiving, from the UE, PDSCH HARQ-ACK feedback for the PDSCH associated with the first RAT based at least in part on the relaxed PDSCH HARQ-ACK feedback timeline associated with the DSS deployment.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example associated with adjusting feedback timelines for spectrum sharing deployments, in accordance with the present disclosure.

FIGS. 4-6 are diagrams illustrating examples associated with cell specific reference signal interference cancelation (CRS-IC), in accordance with the present disclosure.

FIGS. 7-8 are diagrams illustrating example processes associated with adjusting feedback timelines for spectrum sharing deployments, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) RAT, aspects of the present disclosure can be applied to other RATs, such as a 3G RAT, a 4G RAT, and/or a RAT subsequent to 5G (e.g., 6G).

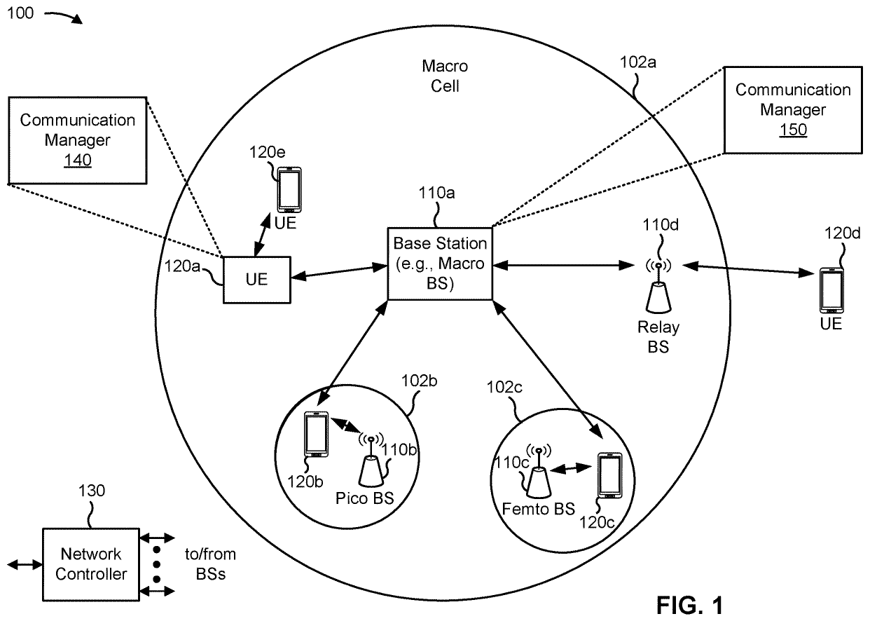

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a base station, an indication of a relaxed PDSCH HARQ-ACK feedback timeline associated with a DSS deployment in which a first RAT and a second RAT share a same frequency band; receive, from the base station, a PDSCH associated with the first RAT; and transmit, to the base station, PDSCH HARQ-ACK feedback for the PDSCH associated with the first RAT based at least in part on the relaxed PDSCH HARQ-ACK feedback timeline associated with the DSS deployment. Additionally, or alternatively, the communication manager 140 may perform one or more other operations described herein.

In some aspects, a base station (e.g., base station 110) may include a communication manager 150. As described in more detail elsewhere herein, the communication manager 150 may transmit, to a UE, an indication of a relaxed PDSCH HARQ-ACK feedback timeline associated with a DSS deployment in which a first RAT and a second RAT share a same frequency band; transmit, to the UE, a PDSCH associated with the first RAT; and receive, from the UE, PDSCH HARQ-ACK feedback for the PDSCH associated with the first RAT based at least in part on the relaxed PDSCH HARQ-ACK feedback timeline associated with the DSS deployment. Additionally, or alternatively, the communication manager 150 may perform one or more other operations described herein.

As indicated above, FIG. 1 is provided as an example. Other examples may differ from what is described with regard to FIG. 1.

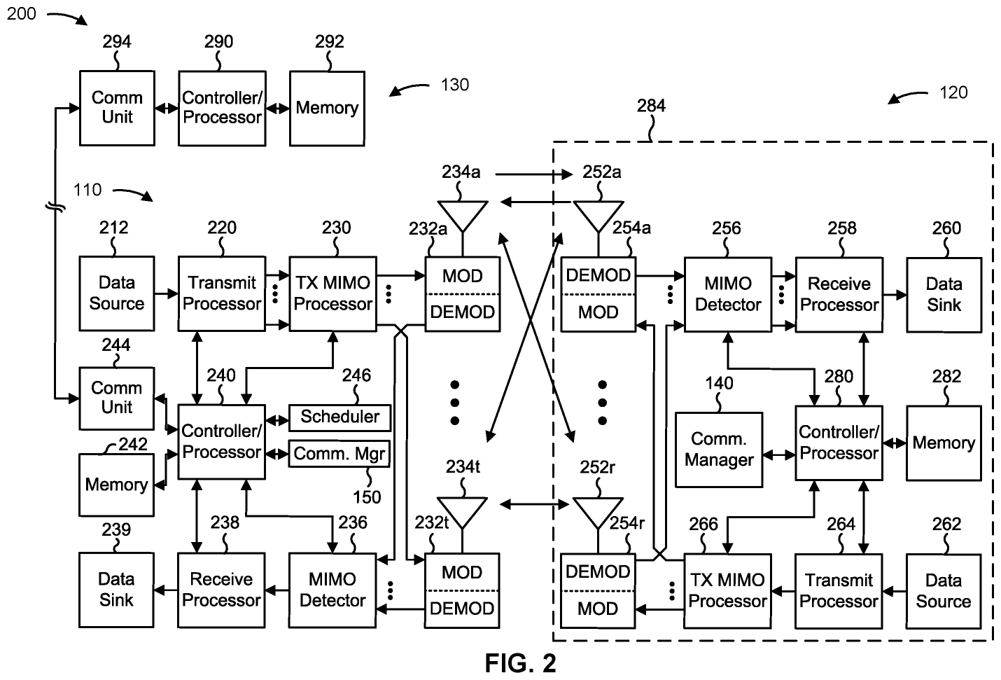

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

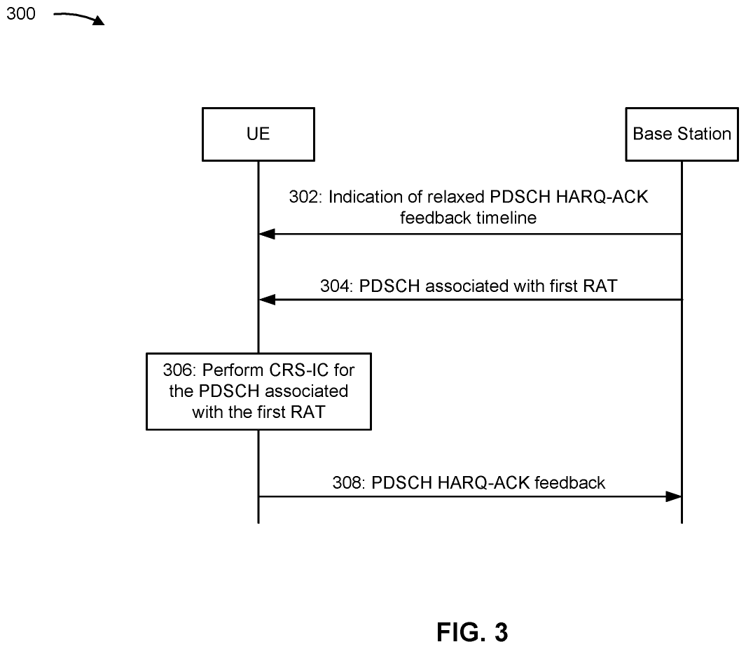

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the ULE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-8).

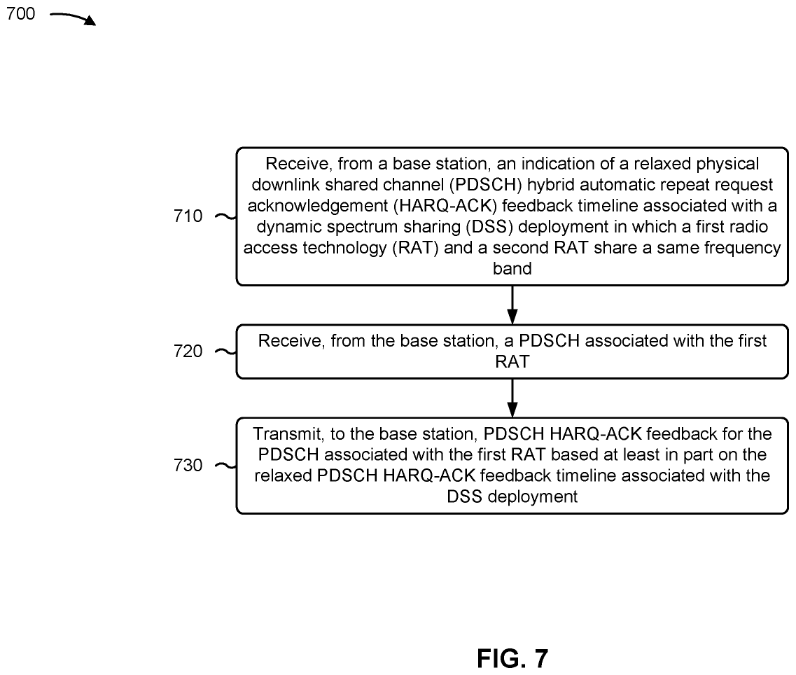

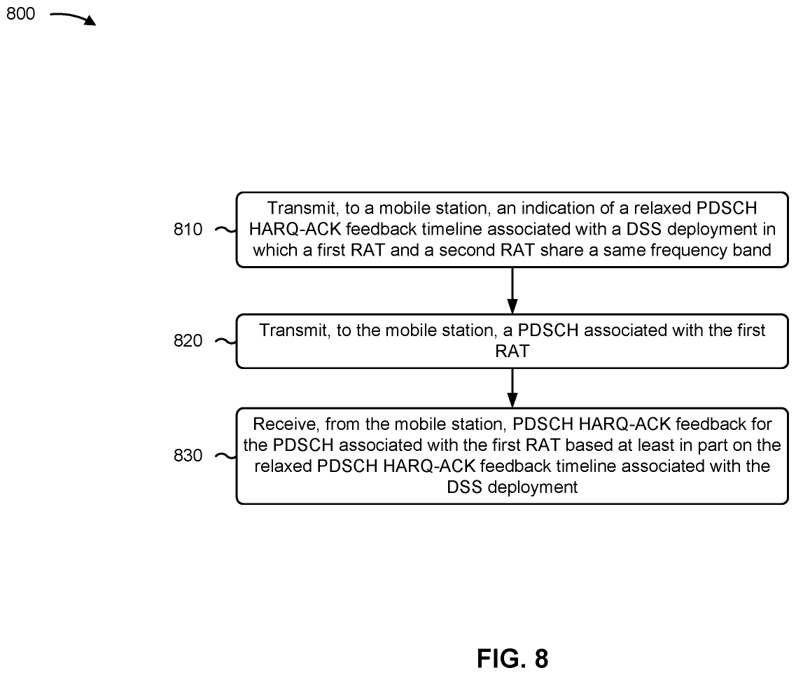

The controller/processor 240 of the base station 110, the controller/processor 280 of the UE 120, and/or any other component(s) of FIG. 2 may perform one or more techniques associated with adjusting feedback timelines for spectrum sharing deployments, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a base station, an indication of a relaxed PDSCH HARQ-ACK feedback timeline associated with a DSS deployment in which a first RAT and a second RAT share a same frequency band; means for receiving, from the base station, a PDSCH associated with the first RAT; and/or means for transmitting, to the base station, PDSCH HARQ-ACK feedback for the PDSCH associated with the first RAT based at least in part on the relaxed PDSCH HARQ-ACK feedback timeline associated with the DSS deployment. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a base station (e.g., base station 110) includes means for transmitting, to a UE, an indication of a relaxed PDSCH HARQ-ACK feedback timeline associated with a DSS deployment in which a first RAT and a second RAT share a same frequency band; means for transmitting, to the UE, a PDSCH associated with the first RAT; and/or means for receiving, from the UE, PDSCH HARQ-ACK feedback for the PDSCH associated with the first RAT based at least in part on the relaxed PDSCH HARQ-ACK feedback timeline associated with the DSS deployment. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

DSS may allow for a deployment of both a first RAT, such as LTE, and a second RAT, such as NR, in a same frequency band. DSS may allow spectrum resources to be dynamically allocated between the first RAT and the second RAT within the same frequency band. In an NR DSS deployment, LTE and NR may share a same carrier to allow soft migration between LTE and NR.

In an LTE deployment, an NR PDSCH demodulation performance of an NR UE may be affected by cell specific reference signal (CRS) interference from a neighbor LTE cell. A base station associated with the neighbor LTE cell may transmit a CRS, irrespective of whether downlink data is transmitted in the neighbor LTE cell. The CRS transmitted in the neighbor LTE cell may cause CRS interference, thereby negatively impacting the NR PDSCH demodulation performance for the NR UE. An impact of the CRS interference from the neighbor LTE cell may be more prominent for a lightly loaded network with a non-colliding CRS configuration.

An LTE UE may be configured to handle CRS interference from a neighbor LTE cell. For example, the LTE UE may be configured with CRS-IC to mitigate the CRS interference from the neighbor LTE cell. However, the NR UE may not be configured with CRS-IC. In other words, the NR UE may not be configured to mitigate the CRS interference from the neighbor LTE cell. The NR UE without CRS-IC may be associated with a relative throughput degradation as compared to the LTE UE with CRS-IC when the CRS interference from the neighbor LTE cell is a dominant interference.

In various aspects of techniques and apparatuses described herein, a UE may receive, from a base station, an indication of a relaxed PDSCH HARQ-ACK feedback timeline associated with a DSS deployment in which a first RAT and a second RAT share a same frequency band. The first RAT may be an NR RAT and the second RAT may be an LTE RAT. The UE may receive, from the base station, a PDSCH associated with the first RAT. The UE may perform a CRS-IC for the PDSCH associated with the first RAT based at least in part on a channel estimation and CRS-IC processing flow associated with the second RAT. The CRS-IC for the PDSCH associated with the first RAT may be based at least in part on samples associated with an output of the channel estimation and CRS-IC processing flow associated with the second RAT. The UE may provide the PDSCH associated with the first RAT, from an output buffer associated with the UE, to the channel estimation and CRS-IC processing flow associated with the second RAT based at least in part on CRS interference on the PDSCH associated with the first RAT. The CRS interference may be associated with a neighbor cell associated with the second RAT. The UE may transmit, to the base station, PDSCH HARQ-ACK feedback for the PDSCH associated with the first RAT based at least in part on the relaxed PDSCH HARQ-ACK feedback timeline associated with the DSS deployment. The relaxed PDSCH HARQ-ACK feedback timeline may enable the UE to perform the CRS-IC for the PDSCH associated with the first RAT based at least in part on the channel estimation and CRS-IC processing flow associated with the second RAT.

In some aspects, a UE may determine whether CRS-IC is needed for an NR PDSCH when the UE is configured with an LTE cell and an NR cell on a same carrier in a non-standalone deployment. In the non-standalone deployment, NR may be used in conjunction with an existing LTE infrastructure. In a standalone deployment, NR may not be dependent on the existing LTE infrastructure. In some aspects, in both the non-standalone deployment and the standalone deployment, the UE may determine whether the CRS-IC is needed for the NR PDSCH when an NR cell is configured with a physical downlink control channel (PDCCH) search space that does not start from a first symbol of a slot. In some aspects, in both the non-standalone deployment and the standalone deployment, the UE may determine whether the CRS-IC is needed for the NR PDSCH when the NR cell is configured with a PDSCH rate matching pattern associated with an LTE CRS. In some aspects, in both the non-standalone deployment and the standalone deployment, the UE may determine whether the CRS-IC is needed for the NR PDSCH when the NR cell is configured with an alternative additional demodulation reference signal (DMIRS) location (additionalDMRS-DL-Alt).

FIG. 3 is a diagram illustrating an example 300 associated with adjusting feedback timelines for spectrum sharing deployments, in accordance with the present disclosure. As shown in FIG. 3, example 300 includes communication between a UE (e.g., UE 120) and a base station (e.g., base station 110). In some aspects, the UE and the base station may be included in a wireless network, such as wireless network 100.

As shown by reference number 302, the UE (or mobile station) may receive, from the base station, an indication of a relaxed PDSCH HARQ-ACK feedback timeline associated with a DSS deployment in which a first RAT and a second RAT share a same frequency band. In some aspects, the first RAT may be an NR RAT and the second RAT may be an LTE RAT. In some aspects, the UE may be associated with a non-standalone mode or a standalone mode. In some aspects, the relaxed PDSCH HARQ-ACK feedback timeline may be longer in duration as compared to a PDSCH HARQ-ACK feedback timeline associated with the first RAT.

As an example, the relaxed PDSCH HARQ-ACK feedback timeline associated with the DSS deployment may be at least 42 symbols. The PDSCH HARQ-ACK feedback timeline associated with the second RAT may be at least 42 symbols. The PDSCH HARQ-ACK feedback timeline associated with the first RAT may be 8 symbols.

In some aspects, the UE may transmit, to the base station, capability signaling that indicates a capability to support the relaxed PDSCH HARQ-ACK feedback timeline in the DSS deployment. The indication of the relaxed PDSCH HARQ-ACK feedback timeline for the DSS deployment may be based at least in part on the capability signaling.

As shown by reference number 304, the UE may receive, from the base station, a PDSCH associated with the first RAT. In other words, the PDSCH may be associated with the NR RAT.

In some aspects, the UE may determine whether to perform CRS-IC for the PDSCH associated with the first RAT. In some aspects, the UE may determine whether to perform the CRS-IC for the PDSCH associated with the first RAT based at least in part on a PDCCH search space not starting from a first symbol of a slot. In some aspects, the UE may determine whether to perform the CRS-IC for the PDSCH associated with the first RAT based at least in part on a PDSCH rate matching pattern configured for a CRS associated with the second RAT. In some aspects, the UE may determine whether to perform the CRS-IC for the PDSCH associated with the first RAT based at least in part on an alternative additional DMRS location configuration.

As shown by reference number 306, the UE may perform the CRS-IC for the PDSCH associated with the first RAT based at least in part on a channel estimation and CRS-IC processing flow associated with the second RAT. The CRS-IC for the PDSCH associated with the first RAT may be based at least in part on samples associated with an output of the channel estimation and CRS-IC processing flow associated with the second RAT. In some aspects, the UE may provide the PDSCH associated with the first RAT, from an output buffer associated with the UE, to the channel estimation and CRS-IC processing flow associated with the second RAT based at least in part on CRS interference on the PDSCH associated with the first RAT. The CRS interference may be associated with a neighbor cell associated with the second RAT.

In some aspects, the UE may provide the PDSCH associated with the first RAT, from the output buffer associated with the UE, to the channel estimation processing flow associated with the first RAT based at least in part on a lack of CRS interference from the neighbor cell associated with the second RAT on the PDSCH associated with the first RAT.

As shown by reference number 308, the UE may transmit, to the base station, PDSCH HARQ-ACK feedback for the PDSCH associated with the first RAT based at least in part on the relaxed PDSCH HARQ-ACK feedback timeline associated with the DSS deployment. The UE may receive the PDSCH associated with the first RAT and transmit the PDSCH HARQ-ACK feedback for the PDSCH associated with the first RAT within a time duration that complies with the relaxed PDSCH HARQ-ACK feedback timeline. In some aspects, the relaxed PDSCH HARQ-ACK feedback timeline may enable the UE to perform the CRS-IC for the PDSCH associated with the first RAT based at least in part on the channel estimation and CRS-IC processing flow associated with the second RAT.

As indicated above, FIG. 3 is provided as an example. Other examples may differ from what is described with regard to FIG. 3.

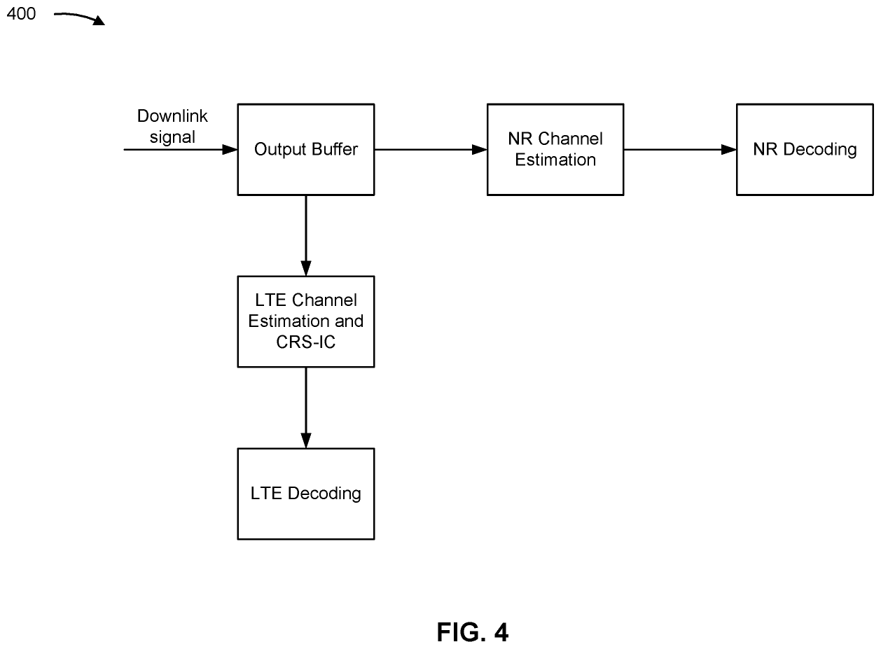

FIG. 4 is a diagram illustrating an example 400 associated with CRS-IC, in accordance with the present disclosure.

An output buffer of a UE may be shared between LTE and NR in a DSS scenario. The output buffer may be a fast Fourier transform (FFT) output buffer. A downlink signal may be received at the output buffer. The downlink signal may be associated with a PDSCH. The downlink signal may be an LTE signal or an NR signal. When the downlink signal is the LTE signal, an LTE channel estimation and a CRS-IC may be performed based at least in part on the LTE signal. An LTE decoding may be performed based at least in part on the LTE signal. When the downlink signal is the NR signal, an NR channel estimation and an NR decoding may be performed based at least in part on the NR signal. In this example, a CRS-IC is not needed for the NR signal. When the CRS-IC is not needed for the NR signal, samples associated with an output of the output buffer may be directly provided for the NR channel estimation and the NR decoding.

As indicated above, FIG. 4 is provided as an example. Other examples may differ from what is described with regard to FIG. 4.

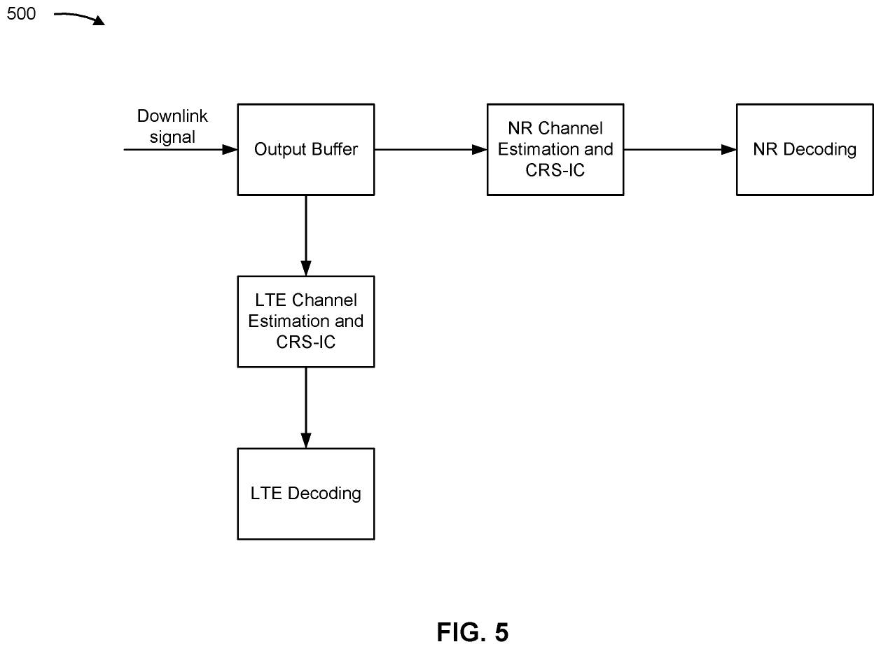

FIG. 5 is a diagram illustrating an example 500 associated with CRS-IC, in accordance with the present disclosure.

An output buffer of a UE may be shared between LTE and NR in a DSS scenario. The output buffer may be an FFT output buffer. A downlink signal may be received at the output buffer. The downlink signal may be associated with a PDSCH. The downlink signal may be an LTE signal or an NR signal. When the downlink signal is the LTE signal, an LTE channel estimation and a CRS-IC may be performed based at least in part on the LTE signal. An LTE decoding may be performed based at least in part on the LTE signal. When the downlink signal is the NR signal, an NR channel estimation and a CRS-IC may be performed based at least in part on the NR signal. An NR decoding may be performed based at least in part on the NR signal. In this example, CRS-IC is needed for both the LTE signal and the NR signal. In some cases, implementing CRS-IC with both the LTE channel estimation and the NR channel estimation may be costly since CRS-IC functionality is implemented for both LTE signals and NR signals.

As indicated above, FIG. 5 is provided as an example. Other examples may differ from what is described with regard to FIG. 5.

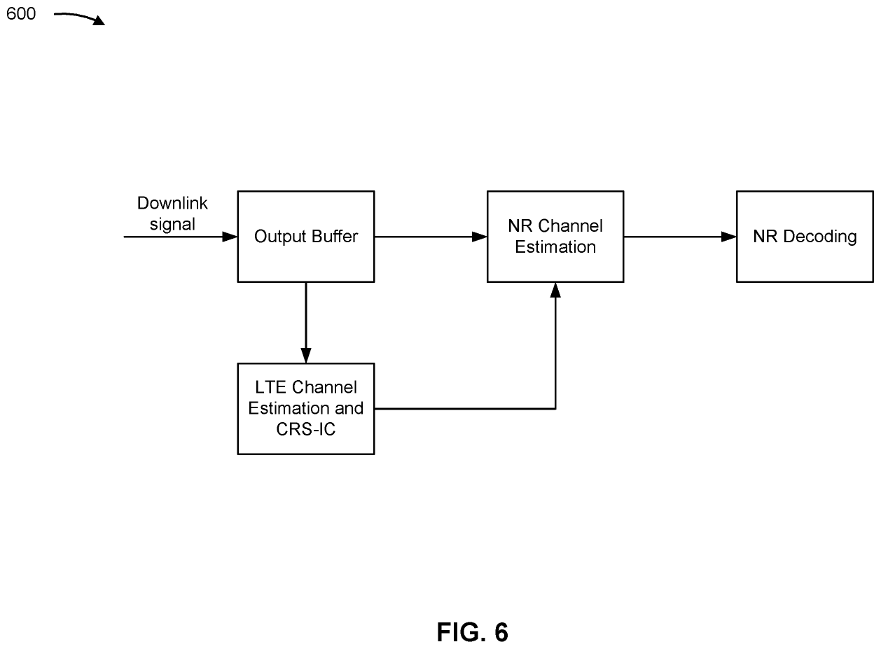

FIG. 6 is a diagram illustrating an example 600 associated with CRS-IC, in accordance with the present disclosure.

An output buffer of a UE may be shared between LTE and NR in a DSS scenario. The output buffer may be an FFT output buffer. A downlink signal may be received at the output buffer. The downlink signal may be associated with a PDSCH. The downlink signal may be an NR signal. When CRS-IC is needed for the NR signal, an LTE channel estimation and a CRS-IC may be performed based at least in part on the NR signal. The CRS-IC may be performed for the NR signal using an LTE CRS processing flow associated with performing CRS-IC for LTE signals. An output of the LTE channel estimation and the CRS-IC may be used to perform an NR channel estimation and an NR decoding. In other words, samples associated with the output of the LTE channel estimation may be provided for the NR channel estimation and the NR decoding. In this case, the CRS-IC associated with the LTE channel estimation may be reused for the NR signal, thereby avoiding CRS-IC functionality being duplicated for both LTE signals and NR signals.

As indicated above, FIG. 6 is provided as an example. Other examples may differ from what is described with regard to FIG. 6.

In some aspects, a UE (e.g., UE 120) may receive a downlink signal via a PDSCH from a base station. The UE may transmit a PDSCH HARQ-ACK feedback based at least in part on the downlink signal received via the PDSCH. The UE may transmit the PDSCH HARQ-ACK feedback after a channel estimation (e.g., an NR channel estimation, or an LTE channel estimation with CRS-IC) and after a signal decoding (e.g., an NR decoding or an LTE decoding). The downlink signal may be associated with LTE or NR, and LTE and NR may be associated with different timelines for PDSCH HARQ-ACK feedback. An LTE UE may provide HARQ-ACK feedback 42 symbols (or three slots) after a PDSCH symbol. In other words, a duration between a receipt of an LTE signal and an end of an LTE channel estimation, CRS-IC, and/or LTE decoding may be 42 symbols. For an NR UE associated with a 15 kHz subcarrier spacing, the NR UE may provide HARQ-ACK feedback as early as 8 symbols or 13-14 symbols after a PDSCH symbol. In other words, a duration between a receipt of an NR signal and an end of an NR channel estimation and/or NR decoding may be 8 symbols. For the NR UE, an actual HARQ-ACK feedback timeline value (e.g., K1) may be indicated via downlink control information (DCI) signaling or may be configured via radio resource control (RRC) signaling, where K1 may be defined as a quantity of symbols.

In some aspects, when CRS-IC is needed for the NR signal and the CRS-IC is performed for the NR signal using an LTE CRS processing flow associated with performing CRS-IC for LTE signals (as shown in FIG. 6), a PDSCH HARQ-ACK feedback timeline problem may occur. The PDSCH HARQ-ACK feedback timeline problem may occur since an NR PDSCH HARQ-ACK feedback timeline may be 8 symbols, whereas an LTE PDSCH HARQ-ACK feedback timeline may be 42 symbols. The LTE channel estimation and CRS-IC may be designed based at least in part on the LTE PDSCH HARQ-ACK feedback timeline of 42 symbols. When the LTE channel estimation and CRS-IC are used for performing CRS-IC for the NR signal, more than 8 symbols may occur before the NR UE provides the HARQ-ACK feedback, thereby violating an NR PDSCH HARQ-ACK feedback timeline requirement of 8 symbols.

In some aspects, a UE (e.g., UE 120) may modify the NR PDSCH HARQ-ACK feedback timeline of 8 symbols to correspond to the LTE PDSCH HARQ-ACK feedback timeline of 42 symbols. In other words, the NR PDSCH HARQ-ACK feedback timeline may be 42 symbols. The UE may be configured with both an LTE cell and an NR cell (e.g., the UE may be a multi-mode UE). The UE may reuse the LTE CRS processing flow associated with performing CRS-IC for LTE signals. The UE may reuse the LTE CRS processing flow to implement CRS-IC for an NR PDSCH based at least in part on the NR PDSCH HARQ-ACK feedback timeline being modified to correspond to the LTE PDSCH HARQ-ACK feedback timeline of 42 symbols.

In some aspects, the UE may transmit, to a base station (e.g., base station 110), capability signaling that indicates a capability for a relaxed PDSCH HARQ-ACK feedback timeline for a DSS scenario, in which LTE and NR may share a same carrier to allow migration between LTE and NR. “Relaxed PDSCH HARQ-ACK feedback timeline” may refer to a longer timeline. The base station may receive the capability signaling from the UE. The base station may transmit, to the UE, an indication of a relaxed HARQ-ACK feedback timeline (e.g., a K1 value) based at least in part on the capability signaling indicating the capability for the relaxed PDSCH HARQ-ACK feedback timeline for the DSS scenario. The relaxed HARQ-ACK feedback timeline may be at least 42 symbols (or three slots) instead of 8 symbols. As a result, the UE may reuse the LTE CRS processing flow to implement CRS-IC for the NR PDSCH, and HARQ-ACK feedback based at least in part on the NR PDSCH may be transmitted from the UE to the base station within the relaxed HARQ-ACK feedback timeline of at least 42 symbols.

FIG. 7 is a diagram illustrating an example process 700 performed, for example, by a UE, in accordance with the present disclosure. Example process 700 is an example where the UE (e.g., UE 120) performs operations associated with adjusting feedback timelines for spectrum sharing deployments.

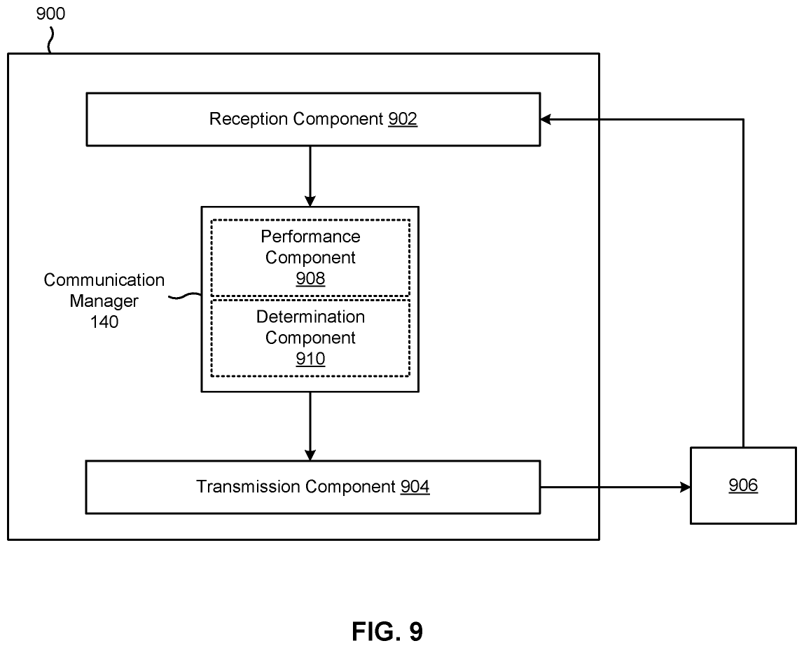

As shown in FIG. 7, in some aspects, process 700 may include receiving, from a base station, an indication of a relaxed PDSCH HARQ-ACK feedback timeline associated with a DSS deployment in which a first radio access technology (RAT) and a second RAT share a same frequency band (block 710). For example, the UE (e.g., using communication manager 140 and/or reception component 902, depicted in FIG. 9) may receive, from a base station, an indication of a relaxed PDSCH HARQ-ACK feedback timeline associated with a DSS deployment in which a first RAT and a second RAT share a same frequency band, as described above in connection with FIGS. 3-6.

As further shown in FIG. 7, in some aspects, process 700 may include receiving, from the base station, a PDSCH associated with the first RAT (block 720). For example, the UE (e.g., using communication manager 140 and/or reception component 902, depicted in FIG. 9) may receive, from the base station, a PDSCH associated with the first RAT, as described above in connection with FIGS. 3-6.

As further shown in FIG. 7, in some aspects, process 700 may include transmitting, to the base station, PDSCH HARQ-ACK feedback for the PDSCH associated with the first RAT based at least in part on the relaxed PDSCH HARQ-ACK feedback timeline associated with the DSS deployment (block 730). For example, the UE (e.g., using communication manager 140 and/or transmission component 904, depicted in FIG. 9) may transmit, to the base station, PDSCH HARQ-ACK feedback for the PDSCH associated with the first RAT based at least in part on the relaxed PDSCH HARQ-ACK feedback timeline associated with the DSS deployment, as described above in connection with FIGS. 3-6.

Process 700 may include additional aspects, such as any single aspect or any combination of aspects described below and/or in connection with one or more other processes described elsewhere herein.

In a first aspect, process 700 includes performing a CRS-IC for the PDSCH associated with the first RAT based at least in part on a channel estimation and CRS-IC processing flow associated with the second RAT, wherein the CRS-IC for the PDSCH associated with the first RAT is based at least in part on samples associated with an output of the channel estimation and CRS-IC processing flow associated with the second RAT.

In a second aspect, alone or in combination with the first aspect, process 700 includes providing the PDSCH associated with the first RAT, from an output buffer associated with the UE, to a channel estimation and CRS-IC processing flow associated with the second RAT based at least in part on CRS interference on the PDSCH associated with the first RAT, wherein the CRS interference is associated with a neighbor cell associated with the second RAT.

In a third aspect, alone or in combination with one or more of the first and second aspects, process 700 includes providing the PDSCH associated with the first RAT, from an output buffer associated with the UE, to a channel estimation processing flow associated with the first RAT based at least in part on a lack of CRS interference from a neighbor cell associated with the second RAT on the PDSCH associated with the first RAT.

In a fourth aspect, alone or in combination with one or more of the first through third aspects, process 700 includes transmitting, to the base station, capability signaling that indicates a capability to support the relaxed PDSCH HARQ-ACK feedback timeline in the DSS deployment, wherein the indication of the relaxed PDSCH HARQ-ACK feedback timeline for the DSS deployment is based at least in part on the capability signaling.

In a fifth aspect, alone or in combination with one or more of the first through fourth aspects, process 700 includes determining to perform CRS-IC for the PDSCH associated with the first RAT based at least in part on a PDCCH search space not starting from a first symbol of a slot.

In a sixth aspect, alone or in combination with one or more of the first through fifth aspects, process 700 includes determining to perform CRS-IC for the PDSCH associated with the first RAT based at least in part on a PDSCH rate matching pattern configured for a CRS associated with the second RAT.

In a seventh aspect, alone or in combination with one or more of the first through sixth aspects, process 700 includes determining to perform CRS-IC for the PDSCH associated with the first RAT based at least in part on an alternative additional DMRS location configuration.

In an eighth aspect, alone or in combination with one or more of the first through seventh aspects, the first RAT is a New Radio RAT and the second RAT is a Long Term Evolution RAT.

In a ninth aspect, alone or in combination with one or more of the first through eighth aspects, the relaxed PDSCH HARQ-ACK feedback timeline is longer in duration as compared to a PDSCH HARQ-ACK feedback timeline associated with the first RAT.

In a tenth aspect, alone or in combination with one or more of the first through ninth aspects, the UE is associated with a non-standalone mode or a standalone mode.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with adjusting feedback timelines for spectrum sharing deployments.

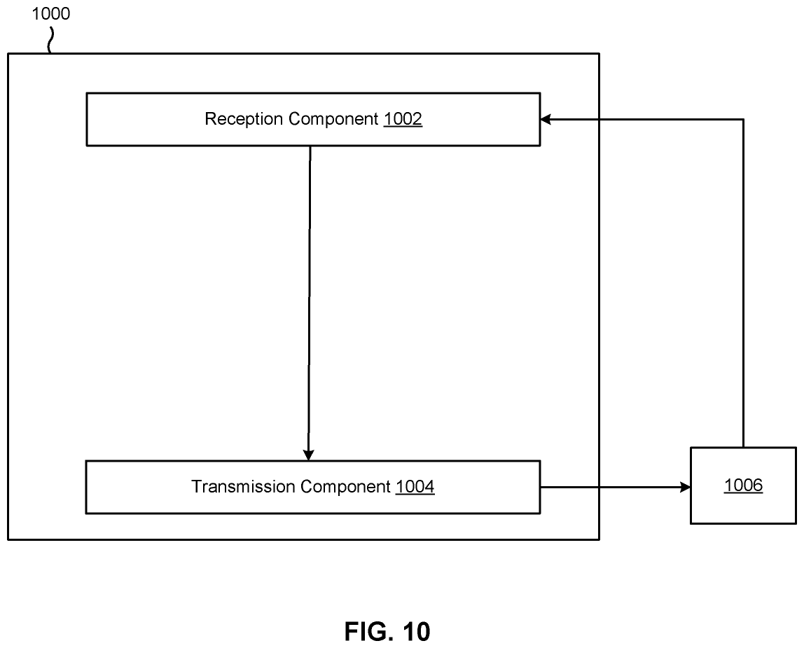

As shown in FIG. 8, in some aspects, process 800 may include transmitting, to a UE, an indication of a relaxed PDSCH HARQ-ACK feedback timeline associated with a DSS deployment in which a first RAT and a second RAT share a same frequency band (block 810). For example, the base station (e.g., using communication manager 150 and/or transmission component 1004, depicted in FIG. 10) may transmit, to a UE, an indication of a relaxed PDSCH HARQ-ACK feedback timeline associated with a DSS deployment in which a first RAT and a second RAT share a same frequency band, as described above in connection with FIGS. 3-6.

As further shown in FIG. 8, in some aspects, process 800 may include transmitting, to the UE, a PDSCH associated with the first RAT (block 820). For example, the base station (e.g., using communication manager 150 and/or transmission component 1004, depicted in FIG. 10) may transmit, to the UE, a PDSCH associated with the first RAT, as described above in connection with FIGS. 3-6.

As further shown in FIG. 8, in some aspects, process 800 may include receiving, from the UE, PDSCH HARQ-ACK feedback for the PDSCH associated with the first RAT based at least in part on the relaxed PDSCH HARQ-ACK feedback timeline associated with the DSS deployment (block 830). For example, the base station (e.g., using communication manager 150 and/or reception component 1002, depicted in FIG. 10) may receive, from the UE, PDSCH HARQ-ACK feedback for the PDSCH associated with the first RAT based at least in part on the relaxed PDSCH HARQ-ACK feedback timeline associated with the DSS deployment, as described above in connection with FIGS. 3-6.

Process 800 may include additional aspects, such as any single aspect or any combination of aspects described below and/or in connection with one or more other processes described elsewhere herein.

In a first aspect, process 800 includes receiving, from the UE, capability signaling that indicates a capability to support the relaxed PDSCH HARQ-ACK feedback timeline in the DSS deployment, wherein the indication of the relaxed PDSCH HARQ-ACK feedback timeline for the DSS deployment is based at least in part on the capability signaling.

In a second aspect, alone or in combination with the first aspect, the first RAT is a New Radio RAT and the second RAT is a Long Term Evolution RAT.

In a third aspect, alone or in combination with one or more of the first and second aspects, the relaxed PDSCH HARQ-ACK feedback timeline is longer in duration as compared to a PDSCH HARQ-ACK feedback timeline associated with the first RAT.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a performance component 908, or a determination component 910, among other examples.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive, from a base station, an indication of a relaxed PDSCH HARQ-ACK feedback timeline associated with a DSS deployment in which a first RAT and a second RAT share a same frequency band. The reception component 902 may receive, from the base station, a PDSCH associated with the first RAT. The transmission component 904 may transmit, to the base station, PDSCH HARQ-ACK feedback for the PDSCH associated with the first RAT based at least in part on the relaxed PDSCH HARQ-ACK feedback timeline associated with the DSS deployment.

The performance component 908 may perform a CRS-IC for the PDSCH associated with the first RAT based at least in part on a channel estimation and CRS-IC processing flow associated with the second RAT, wherein the CRS-IC for the PDSCH associated with the first RAT is based at least in part on samples associated with an output of the channel estimation and CRS-IC processing flow associated with the second RAT. The performance component 908 may provide the PDSCH associated with the first RAT, from an output buffer associated with the UE, to a channel estimation and CRS-IC processing flow associated with the second RAT based at least in part on CRS interference on the PDSCH associated with the first RAT, wherein the CRS interference is associated with a neighbor cell associated with the second RAT. The performance component 908 may provide the PDSCH associated with the first RAT, from the output buffer associated with the UE, to the channel estimation processing flow associated with the first RAT based at least in part on a lack of CRS interference from a neighbor cell associated with the second RAT on the PDSCH associated with the first RAT.

The transmission component 904 may transmit, to the base station, capability signaling that indicates a capability to support the relaxed PDSCH HARQ-ACK feedback timeline in the DSS deployment, wherein the indication of the relaxed PDSCH HARQ-ACK feedback timeline for the DSS deployment is based at least in part on the capability signaling.

The determination component 910 may determine to perform CRS-IC for the PDSCH associated with the first RAT based at least in part on a physical downlink control channel search space not starting from a first symbol of a slot. The determination component 910 may determine to perform CRS-IC for the PDSCH associated with the first RAT based at least in part on a PDSCH rate matching pattern configured for a CRS associated with the second RAT. The determination component 910 may determine to perform CRS-IC for the PDSCH associated with the first RAT based at least in part on an alternative additional DMRS location configuration.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a modem, a demodulator, a MIMO detector, a receive processor, a controller/processor, a memory, or a combination thereof, of the base station described in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the base station described in connection with FIG. 2. In some aspects, the transmission component 1004 may be co-located with the reception component 1002 in a transceiver.

The transmission component 1004 may transmit, to a UE, an indication of a relaxed PDSCH HARQ-ACK feedback timeline associated with a DSS deployment in which a first RAT and a second RAT share a same frequency band. The transmission component 1004 may transmit, to the UE, a PDSCH associated with the first RAT. The reception component 1002 may receive, from the UE, PDSCH HARQ-ACK feedback for the PDSCH associated with the first RAT based at least in part on the relaxed PDSCH HARQ-ACK feedback timeline associated with the DSS deployment. The reception component 1002 may receive, from the UE, capability signaling that indicates a capability to support the relaxed PDSCH HARQ-ACK feedback timeline in the DSS deployment, wherein the indication of the relaxed PDSCH HARQ-ACK feedback timeline for the DSS deployment is based at least in part on the capability signaling.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a mobile station, comprising: receiving, from a base station, an indication of a relaxed physical downlink shared channel (PDSCH) hybrid automatic repeat request acknowledgement (HARQ-ACK) feedback timeline associated with a dynamic spectrum sharing (DSS) deployment in which a first radio access technology (RAT) and a second RAT share a same frequency band; receiving, from the base station, a PDSCH associated with the first RAT; and transmitting, to the base station, PDSCH HARQ-ACK feedback for the PDSCH associated with the first RAT based at least in part on the relaxed PDSCH HARQ-ACK feedback timeline associated with the DSS deployment.

Aspect 2: The method of Aspect 1, further comprising: performing a cell specific reference signal interference cancelation (CRS-IC) for the PDSCH associated with the first RAT based at least in part on a channel estimation and CRS-IC processing flow associated with the second RAT, wherein the CRS-IC for the PDSCH associated with the first RAT is based at least in part on samples associated with an output of the channel estimation and CRS-IC processing flow associated with the second RAT.

Aspect 3: The method of any of Aspects 1 through 2, further comprising: providing the PDSCH associated with the first RAT, from an output buffer associated with the mobile station, to a channel estimation and CRS-IC processing flow associated with the second RAT based at least in part on cell specific reference signal (CRS) interference on the PDSCH associated with the first RAT, wherein the CRS interference is associated with a neighbor cell associated with the second RAT.

Aspect 4: The method of any of Aspects 1 through 3, further comprising: providing the PDSCH associated with the first RAT, from an output buffer associated with the mobile station, to a channel estimation processing flow associated with the first RAT based at least in part on a lack of cell specific reference signal (CRS) interference from a neighbor cell associated with the second RAT on the PDSCH associated with the first RAT.

Aspect 5: The method of any of Aspects 1 through 4, further comprising: transmitting, to the base station, capability signaling that indicates a capability to support the relaxed PDSCH HARQ-ACK feedback timeline in the DSS deployment, wherein the indication of the relaxed PDSCH HARQ-ACK feedback timeline for the DSS deployment is based at least in part on the capability signaling.

Aspect 6: The method of any of Aspects 1 through 5, further comprising: determining to perform cell specific reference signal interference cancelation (CRS-IC) for the PDSCH associated with the first RAT based at least in part on a physical downlink control channel search space not starting from a first symbol of a slot.

Aspect 7: The method of any of Aspects 1 through 6, further comprising: determining to perform cell specific reference signal interference cancelation (CRS-IC) for the PDSCH associated with the first RAT based at least in part on a PDSCH rate matching pattern configured for a cell specific reference signal (CRS) associated with the second RAT.

Aspect 8: The method of any of Aspects 1 through 7, further comprising: determining to perform cell specific reference signal interference cancelation (CRS-IC) for the PDSCH associated with the first RAT based at least in part on an alternative additional demodulation reference signal location configuration.

Aspect 9: The method of any of Aspects 1 through 8, wherein the first RAT is a New Radio RAT and the second RAT is a Long Term Evolution RAT.

Aspect 10: The method of any of Aspects 1 through 9, wherein the relaxed PDSCH HARQ-ACK feedback timeline is longer in duration as compared to a PDSCH HARQ-ACK feedback timeline associated with the first RAT.

Aspect 11: The method of any of Aspects 1 through 10, wherein the mobile station is associated with a non-standalone mode or a standalone mode.

Aspect 12: A method of wireless communication performed by a base station, comprising: transmitting, to a mobile station, an indication of a relaxed physical downlink shared channel (PDSCH) hybrid automatic repeat request acknowledgement (HARQ-ACK) feedback timeline associated with a dynamic spectrum sharing (DSS) deployment in which a first radio access technology (RAT) and a second RAT share a same frequency band; transmitting, to the mobile station, a PDSCH associated with the first RAT; and receiving, from the mobile station, PDSCH HARQ-ACK feedback for the PDSCH associated with the first RAT based at least in part on the relaxed PDSCH HARQ-ACK feedback timeline associated with the DSS deployment.

Aspect 13: The method of Aspect 12, further comprising: receiving, from the mobile station, capability signaling that indicates a capability to support the relaxed PDSCH HARQ-ACK feedback timeline in the DSS deployment, wherein the indication of the relaxed PDSCH HARQ-ACK feedback timeline for the DSS deployment is based at least in part on the capability signaling.

Aspect 14: The method of any of Aspects 12 through 13, wherein the first RAT is a New Radio RAT and the second RAT is a Long Term Evolution RAT.

Aspect 15: The method of any of Aspects 12 through 14, wherein the relaxed PDSCH HARQ-ACK feedback timeline is longer in duration as compared to a PDSCH HARQ-ACK feedback timeline associated with the first RAT.

Aspect 16: An apparatus for wireless communication at a device, comprising a processor; memory coupled with the processor; and instructions stored in the memory and executable by the processor to cause the apparatus to perform the method of one or more of Aspects 1-11.

Aspect 17: A device for wireless communication, comprising a memory and one or more processors coupled to the memory, the one or more processors configured to perform the method of one or more of Aspects 1-11.

Aspect 18: An apparatus for wireless communication, comprising at least one means for performing the method of one or more of Aspects 1-11.

Aspect 19: A non-transitory computer-readable medium storing code for wireless communication, the code comprising instructions executable by a processor to perform the method of one or more of Aspects 1-11.

Aspect 20: A non-transitory computer-readable medium storing a set of instructions for wireless communication, the set of instructions comprising one or more instructions that, when executed by one or more processors of a device, cause the device to perform the method of one or more of Aspects 1-11.

Aspect 21: An apparatus for wireless communication at a device, comprising a processor; memory coupled with the processor; and instructions stored in the memory and executable by the processor to cause the apparatus to perform the method of one or more of Aspects 12-15.

Aspect 22: A device for wireless communication, comprising a memory and one or more processors coupled to the memory, the one or more processors configured to perform the method of one or more of Aspects 12-15.

Aspect 23: An apparatus for wireless communication, comprising at least one means for performing the method of one or more of Aspects 12-15.

Aspect 24: A non-transitory computer-readable medium storing code for wireless communication, the code comprising instructions executable by a processor to perform the method of one or more of Aspects 12-15.

Aspect 25: A non-transitory computer-readable medium storing a set of instructions for wireless communication, the set of instructions comprising one or more instructions that, when executed by one or more processors of a device, cause the device to perform the method of one or more of Aspects 12-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a mobile station, comprising:
a memory; and
one or more processors, coupled to the memory, configured to:
receive, from a base station, an indication of a relaxed physical downlink shared channel (PDSCH) hybrid automatic repeat request acknowledgement (HARQ-ACK) feedback timeline associated with a dynamic spectrum sharing (DSS) deployment in which a first radio access technology (RAT) and a second RAT share a same frequency band;
receive, from the base station, a PDSCH associated with the first RAT; and
transmit, to the base station, PDSCH HARQ-ACK feedback for the PDSCH associated with the first RAT based at least in part on the relaxed PDSCH HARQ-ACK feedback timeline associated with the DSS deployment.

2. The apparatus of claim 1, wherein the one or more processors are further configured to:
perform a cell specific reference signal interference cancelation (CRS-IC) for the PDSCH associated with the first RAT based at least in part on a channel estimation and CRS-IC processing flow associated with the second RAT, wherein the CRS-IC for the PDSCH associated with the first RAT is based at least in part on samples associated with an output of the channel estimation and CRS-IC processing flow associated with the second RAT.

3. The apparatus of claim 1, wherein the one or more processors are further configured to:
provide the PDSCH associated with the first RAT, from an output buffer associated with the mobile station, to a channel estimation and CRS-IC processing flow associated with the second RAT based at least in part on cell specific reference signal (CRS) interference on the PDSCH associated with the first RAT, wherein the CRS interference is associated with a neighbor cell associated with the second RAT.

4. The apparatus of claim 1, wherein the one or more processors are further configured to:
provide the PDSCH associated with the first RAT, from an output buffer associated with the mobile station, to a channel estimation processing flow associated with the first RAT based at least in part on a lack of cell specific reference signal (CRS) interference from a neighbor cell associated with the second RAT on the PDSCH associated with the first RAT.

5. The apparatus of claim 1, wherein the one or more processors are further configured to:
transmit, to the base station, capability signaling that indicates a capability to support the relaxed PDSCH HARQ-ACK feedback timeline in the DSS deployment, wherein the indication of the relaxed PDSCH HARQ-ACK feedback timeline for the DSS deployment is based at least in part on the capability signaling.

6. The apparatus of claim 1, wherein the one or more processors are further configured to:
determine to perform cell specific reference signal interference cancelation (CRS-IC) for the PDSCH associated with the first RAT based at least in part on a physical downlink control channel search space not starting from a first symbol of a slot.

7. The apparatus of claim 1, wherein the one or more processors are further configured to:
determine to perform cell specific reference signal interference cancelation (CRS-IC) for the PDSCH associated with the first RAT based at least in part on a PDSCH rate matching pattern configured for a cell specific reference signal (CRS) associated with the second RAT.

8. The apparatus of claim 1, wherein the one or more processors are further configured to:
determine to perform cell specific reference signal interference cancelation (CRS-IC) for the PDSCH associated with the first RAT based at least in part on an alternative additional demodulation reference signal location configuration.

9. The apparatus of claim 1, wherein the first RAT is a New Radio RAT and the second RAT is a Long Term Evolution RAT.

10. The apparatus of claim 1, wherein the relaxed PDSCH HARQ-ACK feedback timeline is longer in duration as compared to a PDSCH HARQ-ACK feedback timeline associated with the first RAT.

11. The apparatus of claim 1, wherein the mobile station is associated with a non-standalone mode or a standalone mode.

12. An apparatus for wireless communication at a base station, comprising:
a memory; and
one or more processors, coupled to the memory, configured to:
transmit, to a mobile station, an indication of a relaxed physical downlink shared channel (PDSCH) hybrid automatic repeat request acknowledgement (HARQ-ACK) feedback timeline associated with a dynamic spectrum sharing (DSS) deployment in which a first radio access technology (RAT) and a second RAT share a same frequency band;
transmit, to the mobile station, a PDSCH associated with the first RAT; and
receive, from the mobile station, PDSCH HARQ-ACK feedback for the PDSCH associated with the first RAT based at least in part on the relaxed PDSCH HARQ-ACK feedback timeline associated with the DSS deployment.

13. The apparatus of claim 12, wherein the one or more processors are further configured to:
receive, from the mobile station, capability signaling that indicates a capability to support the relaxed PDSCH HARQ-ACK feedback timeline in the DSS deployment, wherein the indication of the relaxed PDSCH HARQ-ACK feedback timeline for the DSS deployment is based at least in part on the capability signaling.

14. The apparatus of claim 12, wherein the first RAT is a New Radio RAT and the second RAT is a Long Term Evolution RAT.

15. The apparatus of claim 12, wherein the relaxed PDSCH HARQ-ACK feedback timeline is longer in duration as compared to a PDSCH HARQ-ACK feedback timeline associated with the first RAT.

16. A method of wireless communication performed by a mobile station, comprising:
receiving, from a base station, an indication of a relaxed physical downlink shared channel (PDSCH) hybrid automatic repeat request acknowledgement (HARQ-ACK) feedback timeline associated with a dynamic spectrum sharing (DSS) deployment in which a first radio access technology (RAT) and a second RAT share a same frequency band;
receiving, from the base station, a PDSCH associated with the first RAT; and
transmitting, to the base station, PDSCH HARQ-ACK feedback for the PDSCH associated with the first RAT based at least in part on the relaxed PDSCH HARQ-ACK feedback timeline associated with the DSS deployment.

17. The method of claim 16, further comprising:
performing a cell specific reference signal interference cancelation (CRS-IC) for the PDSCH associated with the first RAT based at least in part on a channel estimation and CRS-IC processing flow associated with the second RAT, wherein the CRS-IC for the PDSCH associated with the first RAT is based at least in part on samples associated with an output of the channel estimation and CRS-IC processing flow associated with the second RAT.

18. The method of claim 16, further comprising:
providing the PDSCH associated with the first RAT, from an output buffer associated with the mobile station, to a channel estimation and CRS-IC processing flow associated with the second RAT based at least in part on cell specific reference signal (CRS) interference on the PDSCH associated with the first RAT, wherein the CRS interference is associated with a neighbor cell associated with the second RAT.

19. The method of claim 16, further comprising:
providing the PDSCH associated with the first RAT, from an output buffer associated with the mobile station, to a channel estimation processing flow associated with the first RAT based at least in part on a lack of cell specific reference signal (CRS) interference from a neighbor cell associated with the second RAT on the PDSCH associated with the first RAT.

20. The method of claim 16, further comprising:
transmitting, to the base station, capability signaling that indicates a capability to support the relaxed PDSCH HARQ-ACK feedback timeline in the DSS deployment, wherein the indication of the relaxed PDSCH HARQ-ACK feedback timeline for the DSS deployment is based at least in part on the capability signaling.

21. The method of claim 16, further comprising:
determining to perform cell specific reference signal interference cancelation (CRS-IC) for the PDSCH associated with the first RAT based at least in part on a physical downlink control channel search space not starting from a first symbol of a slot.

22. The method of claim 16, further comprising:
determining to perform cell specific reference signal interference cancelation (CRS-IC) for the PDSCH associated with the first RAT based at least in part on a PDSCH rate matching pattern configured for a cell specific reference signal (CRS) associated with the second RAT.

23. The method of claim 16, further comprising:
determining to perform cell specific reference signal interference cancelation (CRS-IC) for the PDSCH associated with the first RAT based at least in part on an alternative additional demodulation reference signal location configuration.

24. The method of claim 16, wherein the first RAT is a New Radio RAT and the second RAT is a Long Term Evolution RAT.

25. The method of claim 16, wherein the relaxed PDSCH HARQ-ACK feedback timeline is longer in duration as compared to a PDSCH HARQ-ACK feedback timeline associated with the first RAT.

26. The method of claim 16, wherein the mobile station is associated with a non-standalone mode or a standalone mode.

27. A method of wireless communication performed by a base station, comprising:
transmitting, to a mobile station, an indication of a relaxed physical downlink shared channel (PDSCH) hybrid automatic repeat request acknowledgement (HARQ-ACK) feedback timeline associated with a dynamic spectrum sharing (DSS) deployment in which a first radio access technology (RAT) and a second RAT share a same frequency band;
transmitting, to the mobile station, a PDSCH associated with the first RAT; and
receiving, from the mobile station, PDSCH HARQ-ACK feedback for the PDSCH associated with the first RAT based at least in part on the relaxed PDSCH HARQ-ACK feedback timeline associated with the DSS deployment.

28. The method of claim 27, further comprising:
receiving, from the mobile station, capability signaling that indicates a capability to support the relaxed PDSCH HARQ-ACK feedback timeline in the DSS deployment, wherein the indication of the relaxed PDSCH HARQ-ACK feedback timeline for the DSS deployment is based at least in part on the capability signaling.

29. The method of claim 27, wherein the first RAT is a New Radio RAT and the second RAT is a Long Term Evolution RAT.

30. The method of claim 27, wherein the relaxed PDSCH HARQ-ACK feedback timeline is longer in duration as compared to a PDSCH HARQ-ACK feedback timeline associated with the first RAT.
